(19) United States
(12) Patent Application Publication
(10) Pub. No.: US 2024/0033887 A1
(43) Pub. Date: Feb. 1, 2024

(54) BUSHING PULLER ASSEMBLY

(71) Applicant: Kennametal Inc., Latrobe, PA (US)

(72) Inventors: Keith Andrews, Milton, WV (US); Travis Hurley, Davin, WV (US)

(21) Appl. No.: 17/815,560

(22) Filed: Jul. 27, 2022

(51) Int. Cl. B25B 27/06

(52) U.S. Cl. CPC B25B 27/062

(57) ABSTRACT

A bushing puller assembly may include a bolt and a nut. The bolt may include a threaded shaft having first and second ends, a ball bearing disposed at the first end, and a head disposed at the second end. The nut may be threadedly attached to the first end of the threaded shaft.

### FIELD OF THE DISCLOSURE

The disclosure relates to bushing puller assemblies that may be used to pull/remove bushings from blocks, and to methods of use thereof.

### BACKGROUND

Bushings that are attached to blocks can be difficult to remove. Frequently, torches are used to remove bushings from blocks. However, this can harm the block and involve significant time and cost.

A bushing puller assembly is needed which may reduce one or more issues associated with pulling/removing bushings from blocks.

### SUMMARY

In one embodiment, a bushing puller assembly is disclosed. The bushing puller assembly may comprise a bolt and a nut. The bolt may comprise a threaded shaft having first and second ends, a ball bearing disposed at the first end, and a head disposed at the second end. The nut may be threadedly attached to the first end of the threaded shaft.

In another embodiment, a varying bushing puller assembly is disclosed. The bushing puller assembly may comprise a bolt and a nut. The bolt may comprise a threaded shaft having first and second ends, and a head disposed at the second end. The nut may be threadedly attached to the first end of the threaded shaft. The nut may comprise a wing extending laterally away from an outer surface of the nut.

In still another embodiment, a method of removing a bushing from an aperture of a block is disclosed. In one step, a first end of a threaded shaft of a bolt is moved through an opening in the bushing, through the aperture of the block, and into a cavity of the block. In another step, a nut is threadedly attached to the first end of the threaded shaft within the cavity of the block. In still another step, a second end of the threaded shaft of the bolt is rotated causing the nut to force the bushing to move out of the aperture of the block. In yet another step, (1) a ball bearing of the first end of the threaded shaft is disposed against a surface of the cavity of the block; and/or (2) a wing of the nut, extending laterally away from an outer surface of the nut, is disposed within the cavity to stabilize the nut within the cavity of the block.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a side perspective view of one embodiment of a bushing puller assembly;

FIG. 2 illustrates a top perspective view of the bushing puller assembly of the embodiment of FIG. 1 attached to a bushing disposed within a block;

FIG. 3 illustrates a side view of the embodiment of FIG. 2 with a nut of the bushing puller assembly disposed in a first position against the bushing prior to the bushing being pulled/removed from the block by the bushing puller assembly;

FIG. 4 illustrates a side view of the embodiment of FIG. 2 with a nut of the bushing puller assembly disposed in a second position after the bushing puller assembly has been used to pull/remove the bushing from the block; and

FIG. 5 illustrates one embodiment of a method of removing a bushing from an aperture of a block.

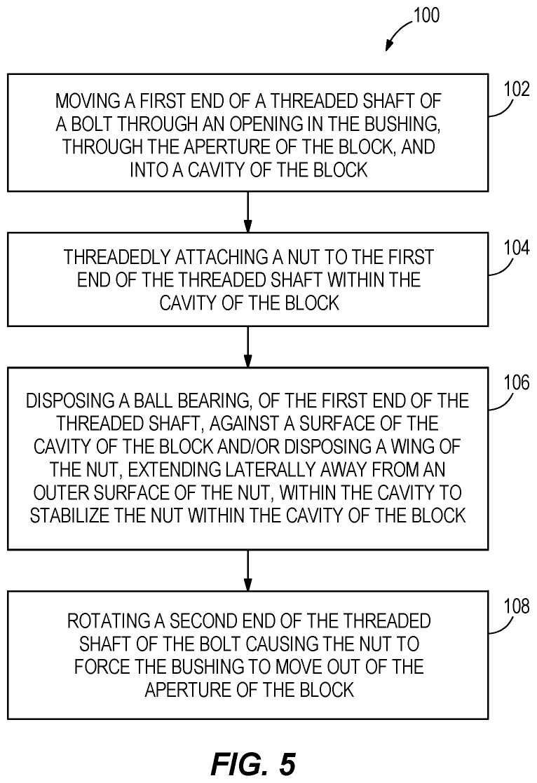

### DETAILED DESCRIPTION

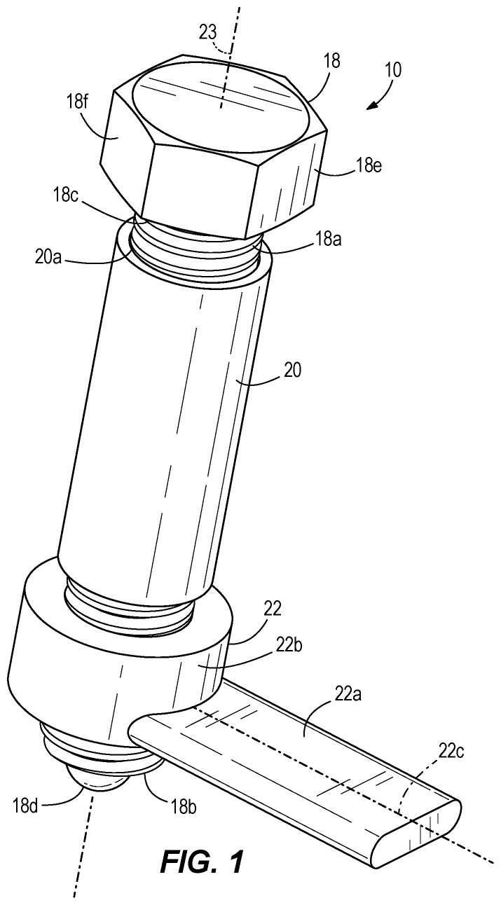

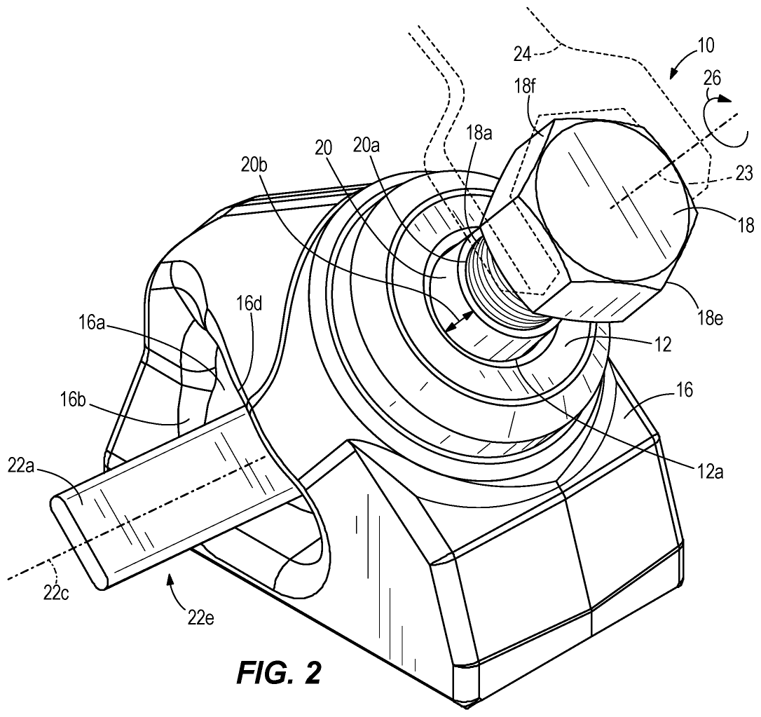

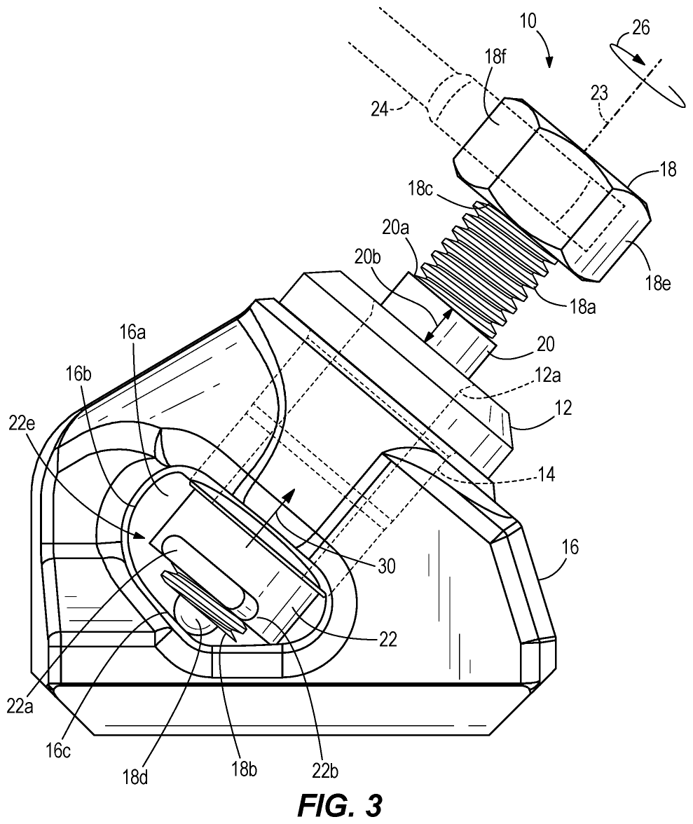

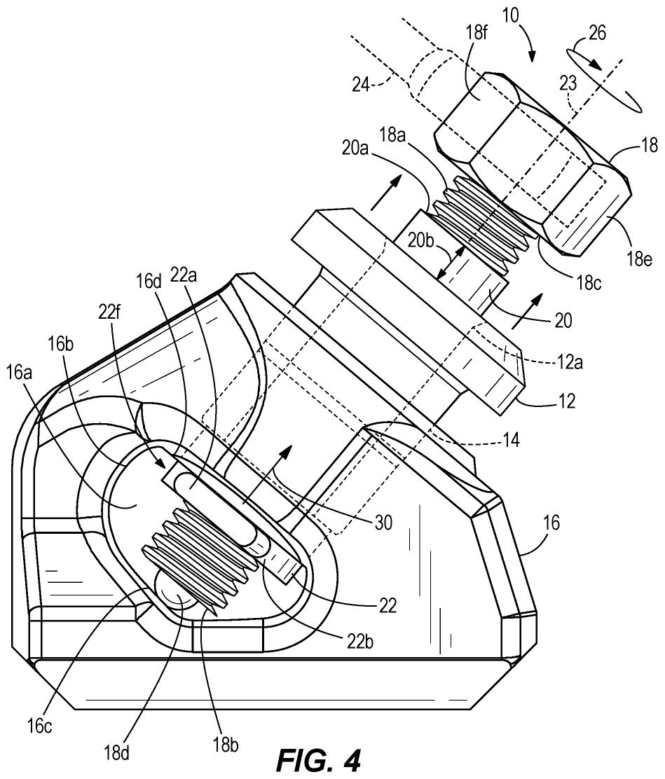

As shown collectively in FIGS. 1-4, in one embodiment a bushing puller assembly 10 is disclosed. The bushing puller assembly 10 may be used to pull/remove a bushing 12 disposed in an aperture 14 of a block 16. The bushing puller assembly 10 may comprise a bolt 18, a collar 20, and a nut 22. In other embodiments, the bushing puller assembly 10 may comprise varying components. The bolt 18 may comprise a threaded shaft 18a having a first end 18b and a second end 18c. A ball bearing 18d may be attached to the first end 18b. A head 18e may be attached to the second end 18c. The head 18e may comprise outer surfaces 18f which are configured in the shape of a hexagon. In other embodiments, the head 18e may comprise varying shapes.

The nut 22 may be threadedly attached to the first end 18b. The nut 22 may comprise a wing 22a extending laterally away from an outer surface 22b of the nut 22. The wing 22a may only be disposed around a portion of the outer surface 22b of the nut 22. A longitudinal axis 22c of the wing 22a may be perpendicular to a rotation axis 23 about which the nut 22 rotates. The collar 20 may comprise a hollow shaft disposed around the threaded shaft 18a. The threaded shaft 18a may be disposed within and through the hollow interior 20a of the collar 20. The collar 20 may be moveably disposed over the threaded shaft 18a between the nut 22 at the first end 18b and the head 18e at the second end 18c in directions 20b parallel to the rotation axis 23 of the bolt 18 and nut 22. Differing sized collars 20 may be used to remove varying sized bushings 12 from varying sized apertures 14 of the block 16.

To remove the bushing 12 from the aperture 14 of the block 16, the collar 20 may be disposed over the threaded shaft 18a of the bolt 18 between the first end 18b and the second end 18c of the threaded shaft 18a. The collar 20 may be aligned with an opening 12a of the bushing 12. The first end 18b of the threaded shaft 18a may then be inserted through the opening 12a of the bushing 12, through the aperture 14 of the block 16, and into a cavity 16a of the block 16. At this time, the collar 20 may be disposed within and against the opening 12a of the bushing 12 which is disposed within the aperture 14 of the block 16. The collar 20 may protect the threaded shaft 18a and assist in aligning the threaded shaft 18a within the opening 12a of the bushing 12.

A tool 24 may then be used to rotate the outer surface 18f of the head 18e of the second end 18c of the nut 18 in direction 26 to rotate the bolt 18 around the rotation axis 23 to threadedly attach the first end 18b of the threaded shaft 18a to the nut 22 within the cavity 16a of the block 16. The tool 24 may comprise any type of tool known in the art to rotate bolts 18. At this time, the wing 22a of the nut 22, extending laterally away from the outer surface 22b of nut 22, may be disposed in a first position 22e against an inner surface 16b of the cavity 16a. This may prevent the nut 22 from rotating in direction 26 as the threaded shaft 18a is rotated in direction 26 and may stabilize the nut 22 within the cavity 16a of the block 16. At this time, the ball bearing 18d at the first end 18b of the threaded shaft 18a may be disposed against a bottom surface 16c of the cavity 16a of the block 16. The ball bearing 18d may protect the first end 18b of the threaded shaft 18a from being damaged. As the threaded shaft 18a is rotated in direction 26, the nut 22 may move relative to the threaded shaft 18a in direction 30 to come into contact and abut against a bottom surface 12b of the bushing 12. As the rotation of the threaded shaft 18a in direction 26 is continued, the nut 22 may continue to move in direction 30 relative to the threaded shaft 18a forcing the bushing 12, abutted against the nut 22, and the collar 20 disposed within and against the opening 12a to move relative to the threaded shaft 18a in direction 30 out of the aperture 14 of the block 16 as the nut 22 moves from within the cavity 16a to within the aperture 14. At this time, the wing 22a of the nut 22 may have moved from the first position 22e to a second position 22f abutted against an upper surface 16d of the cavity 16a which may prevent the wing 22a from moving out of the cavity 16a. The upper surface 16d may comprise another portion of the inner surface 16b of the cavity 16a, or may comprise a second inner surface of the cavity 16a. In other embodiments, the bushing puller assembly 10, or variations thereof, may be used in varying ways to remove the bushing 12 from the block 16.

FIG. 6 illustrates one embodiment of a method 100 of removing a bushing from an aperture of a block. In step 102, a first end of a threaded shaft of a bolt may be moved through an opening in the bushing, through the aperture of the block, and into a cavity of the block. In step 104, a nut may be threadedly attached to the first end of the threaded shaft within the cavity of the block. In step 106, a ball bearing of the first end of the threaded shaft may be disposed against a surface of the cavity of the block, and/or a wing of the nut, extending laterally away from an outer surface of the nut, may be disposed within the cavity to stabilize the nut within the cavity of the block. In step 108, a second end of the threaded shaft of the bolt may be rotated causing the nut to force the bushing to move out of the aperture of the block.

In another embodiment of the method 100, the rotating the second end of the threaded shaft of the bolt may comprise rotating the second end with a tool.

In still another embodiment of the method 100, the rotating the second end of the threaded shaft of the bolt causing the nut to force the bushing to move out of the aperture of the block may comprise the nut moving from within the cavity to within the aperture of the block.

In an additional embodiment of the method 100, the wing may be disposed in a first position against an inner surface of the cavity, and the wing may be moved to a second position against the inner surface of the cavity or against a second inner surface of the cavity.

In another embodiment of the method 100, the threadedly attaching the nut to the first end of the threaded shaft within the cavity of the block may comprise disposing the wing in the first position against the inner surface of the cavity, and the inner surface of the cavity preventing the nut, threadedly attached to the threaded shaft, from rotating in a direction as the threaded shaft is rotated in the direction.

In yet another embodiment of the method 100, the rotating the second end of the threaded shaft of the bolt causing the nut to force the bushing to move out of the aperture of the block may comprise moving the wing from the first position to the second position to prevent the wing from moving out of the cavity.

In still another embodiment of the method 100, a collar may be disposed around the threaded shaft between the first ends and the second ends, and the collar may be disposed in the opening of the bushing.

In yet another embodiment of the method 100, rotating the second end of the threaded shaft of the bolt causing the nut to force the bushing to move out of the aperture of the block may further comprise moving the collar relative to the threaded shaft in a direction parallel to a rotation axis of the bolt.

In still other embodiments, the method 100 may be further varied to not include any of the recited steps, to vary the order or substance of the steps of the method 100, or to add one or more additional steps.

One or more embodiments of the bushing puller assembly 10 and/or the method 100 may reduce one or more issues associated with one or more of the prior bushing puller assemblies and/or methods of use by allowing for bushings 12 to be quickly and easily removed without incurring damage to the block 16. This may save time and expense. The use of differing sized collars 20 may also allow bushings 12 of varying size to be removed from blocks 16.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A bushing puller assembly comprising:
a bolt comprising a threaded shaft having first and second ends, a ball bearing disposed at the first end and a head disposed at the second end; and
a nut threadedly attached to the first end of the threaded shaft.

2. The bushing puller assembly of claim 1 wherein the nut comprises a wing extending laterally away from an outer surface of the nut.

3. The bushing puller assembly of claim 2 wherein a longitudinal axis of the wing is perpendicular to a rotation axis of the nut about which the nut rotates.

4. The bushing puller assembly of claim 2 wherein the wing is only disposed around a portion of the outer surface of the nut.

5. The bushing puller assembly of claim 1 further comprising a collar disposed around the threaded shaft between the first and second ends, the collar configured to move relative to the threaded shaft in directions parallel to a rotation axis of the bolt.

6. A bushing puller assembly comprising:
a bolt comprising a threaded shaft having first and second ends, a head disposed at the second end; and
a nut threadedly attached to the first end of the threaded shaft, the nut comprising a wing extending laterally away from an outer surface of the nut.

7. The bushing puller assembly of claim 6 wherein a longitudinal axis of the wing is perpendicular to a rotation axis of the nut about which the nut rotates.

8. The bushing puller assembly of claim 6 wherein the wing is only disposed around a portion of the outer surface of the nut.

9. The bushing puller assembly of claim 6 wherein the first end comprises a ball bearing.

10. The bushing puller assembly of claim 6 further comprising a collar disposed around the threaded shaft between the first and second ends, the collar configured to move relative to the threaded shaft in directions parallel to a rotation axis of the bolt.

11. A method of removing a bushing from an aperture of a block comprising:
moving a first end of a threaded shaft of a bolt through an opening in the bushing, through the aperture of the block, and into a cavity of the block;
threadedly attaching a nut to the first end of the threaded shaft within the cavity of the block;
rotating a second end of the threaded shaft of the bolt causing the nut to force the bushing to move out of the aperture of the block; and
(1) disposing a ball bearing of the first end of the threaded shaft against a surface of the cavity of the block; and/or (2) disposing a wing of the nut, extending laterally away from an outer surface of the nut, within the cavity to stabilize the nut within the cavity of the block.

12. The method of claim 11 wherein the rotating the second end of the threaded shaft of the bolt comprises rotating the second end with a tool.

13. The method of claim 11 wherein the rotating the second end of the threaded shaft of the bolt causing the nut to force the bushing to move out of the aperture of the block comprises the nut moving from within the cavity to within the aperture of the block.

14. The method of claim 11 comprising (1) disposing the ball bearing of the first end of the threaded shaft against the surface of the cavity of the block.

15. The method of claim 11 comprising (2) disposing the wing of the nut, extending laterally away from the outer surface of the nut, within the cavity to stabilize the nut within the cavity of the block.

16. The method of claim 15 further comprising disposing the wing in a first position against an inner surface of the cavity, and moving the wing to a second position against the inner surface of the cavity or against a second inner surface of the cavity.

17. The method of claim 16 wherein the threadedly attaching the nut to the first end of the threaded shaft within the cavity of the block comprises disposing the wing in the first position against the inner surface of the cavity, and the inner surface of the cavity preventing the nut, threadedly attached to the threaded shaft, from rotating in a direction as the threaded shaft is rotated in the direction.

18. The method of claim 17 wherein the rotating the second end of the threaded shaft of the bolt causing the nut to force the bushing to move out of the aperture of the block comprises moving the wing from the first position to the second position to prevent the wing from moving out of the cavity.

19. The method of claim 11 further comprising disposing a collar around the threaded shaft between the first ends and the second ends, and disposing the collar in the opening of the bushing.

20. The method of claim 19 wherein the rotating the second end of the threaded shaft of the bolt causing the nut to force the bushing to move out of the aperture of the block further comprises moving the collar relative to the threaded shaft in a direction parallel to a rotation axis of the bolt.
